(19) United States
(12) Patent Application Publication
(10) Pub. No.: US 2019/0213527 A1
(43) Pub. Date: Jul. 11, 2019

(54) METHODS FOR MANAGING ON DEMAND ROSTERING AND DEVICES THEREOF

(71) Applicant: ServicePower Technologies PLC, Stockport (GB)

(72) Inventors: Anna Lavygina, Manchester (GB); Alan Crispin, Leeds (GB)

(21) Appl. No.: 15/867,337

(22) Filed: Jan. 10, 2018

(51) Int. Cl. G06Q 10/06

(52) U.S. Cl. CPC G06Q 10/063116

(57) ABSTRACT

A method, non-transitory computer readable medium and roster management computing device for managing on-demand rostering includes receiving one or more roster input parameters. Next, one or more roster constraints associated with the received one or more roster input parameters are obtained. An optimized roster is determined based on the received one or more roster input parameters and the obtained one or more roster constraints. The determined optimized roster on-demand is provided via a customized interface to a client device.

### FIELD

This technology relates to methods for on-demand rostering and devices thereof.

### BACKGROUND

Prior technologies require rostering to be done manually. Traditionally, rostering is performed manually and this requires one or more persons to determine how various tasks and assignments are allocated to appropriate resources. Persons involve with rostering require knowledge of parameters such as availability and skill levels involved of each individual in the organization. However, manual rostering has problems that are impossible or tedious to resolve such as to check for any legal and organizational constraints on employees' schedules.

Additionally, there are many workforce management systems for scheduling and managing personnel. Such systems typically include a basic planning capability to enable a manager to forecast future workloads and employee requirements to service such loads. Some of these systems provide a scheduling capability which allocates employee work hours according to forecasted staffing requirements and employees are assigned to fill these schedules and their assignments are posted. Unfortunately existing technologies fails to consider the complex rules while scheduling. In addition to the complex rules fail environment in which scheduling changes are made, further complexity arises from the fact that multiple different users may be interacting with the schedule and attempting to make schedule changes that impact other parts of an overall schedule. Accordingly, existing technologies fail to provide a rostering on demand systems that assists with scheduling and managing personnel.

### SUMMARY

A method for managing on-demand rostering includes receiving one or more roster input parameters. Next, one or more roster constraints associated with the received one or more roster input parameters are obtained. An optimized roster is determined based on the received one or more roster input parameters and the obtained one or more roster constraints. The determined optimized roster on-demand is provided via a customized interface to a client device.

A roster management computing device comprising a memory coupled to one or more processors which are configured to execute programmed instructions stored in the memory includes receiving one or more roster input parameters. Next, one or more roster constraints associated with the received one or more roster input parameters are obtained. An optimized roster is determined based on the received one or more roster input parameters and the obtained one or more roster constraints. The determined optimized roster on-demand is provided via a customized interface to a client device.

A non-transitory computer readable medium having stored thereon instructions for managing on-demand rostering comprising machine executable code which when executed by at least one processor, causes the processor to perform steps includes receiving one or more roster input parameters. Next, one or more roster constraints associated with the received one or more roster input parameters are obtained. An optimized roster is determined based on the received one or more roster input parameters and the obtained one or more roster constraints. The determined optimized roster on-demand is provided via a customized interface to a client device.

This technology provides a number of advantages including providing more effective methods, devices, and non-transitory computer readable medium for managing on-demand rostering. The disclosed technology automates the rostering process such that the generated rosters have as few constraint violations as possible. Furthermore, the disclosed technology provides a customized interface on which the generated roster is presented to the client device on-demand.

### BRIEF DESCRIPTION OF THE DRAWINGS

FIG. 1 is an example of a network environment with a roster management computing device for on demand rostering;

FIG. 2 is an example of a block diagram of the roster management computing device shown in FIG. 1;

FIG. 3 is an example of a flowchart for a method for on-demand rostering;

FIG. 4 is a table illustrating roster rules and the corresponding penalty for each violation of the rule;

FIG. 5 is an exemplary pseudo-code for generating a random valid roster;

FIG. 6 is an exemplary pseudo-code for swapping shifts between doctors;

FIG. 7 is an exemplary pseudo-code for replacing a doctor; and

FIGS. 8-9 are exemplary pseudo-codes for optimizing a valid random generated roster.

### DETAILED DESCRIPTION

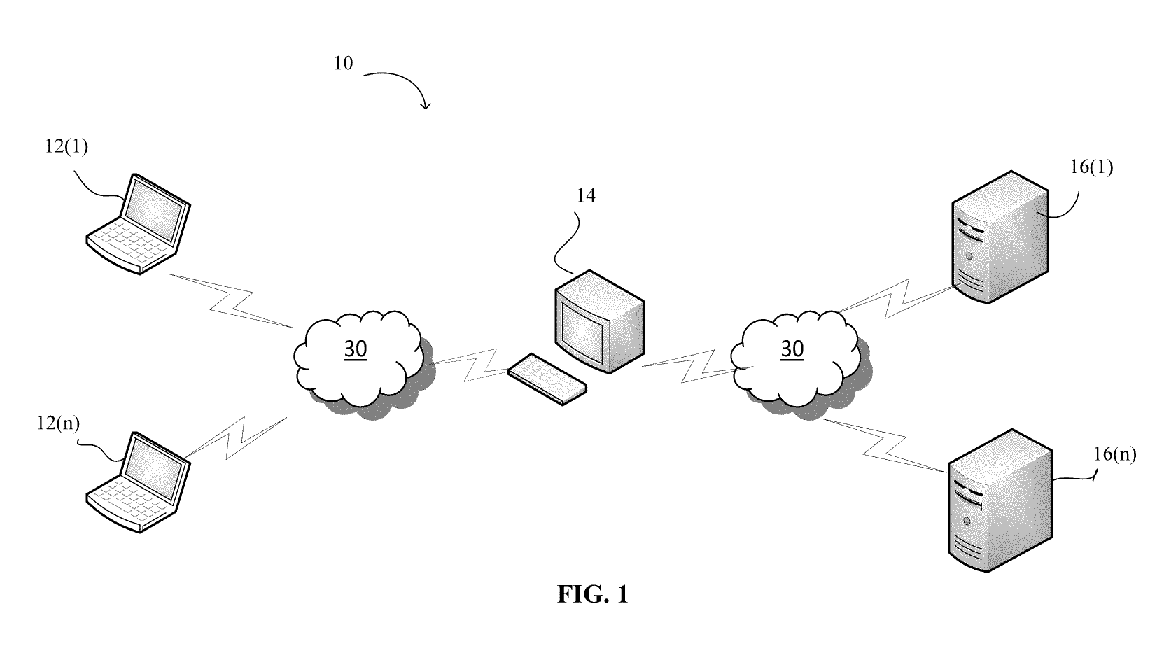

An exemplary network environment 10 with a roster management computing device 14 for on-demand rostering is as illustrated in FIG. 1. The exemplary network environment 10 includes a plurality of client devices 12(1)-12(n), the roster management computing device 14, and plurality of servers 16(1)-16(n) which are coupled together by the communication networks 30, although the environment can include other types and numbers of systems, devices, components, elements and/or communication networks in a variety of other topologies and deployments. While not shown, the exemplary environment 10 may include additional components, such as routers, switches and other devices which are well known to those of ordinary skill in the art and thus will not be described here. This technology provides a number of advantages including providing more effective methods, non-transitory computer readable medium and devices for managing on demand rostering.

Referring more specifically to FIG. 1, roster management computing device 14 interacts with the plurality of client devices 12(1)-12(n) and plurality of servers 16(1)-16(n) through the communication networks 30, although the roster management computing device 14 can interact with the plurality of client computing devices 12(1)-12(n) and the plurality of servers 16(1)-16(n) using other methods or techniques. Communication networks 30 include local area networks (LAN), wide area network (WAN), 3G technologies, GPRS or EDGE technologies, although the communication networks 30 can include other types and numbers of networks and other network topologies.

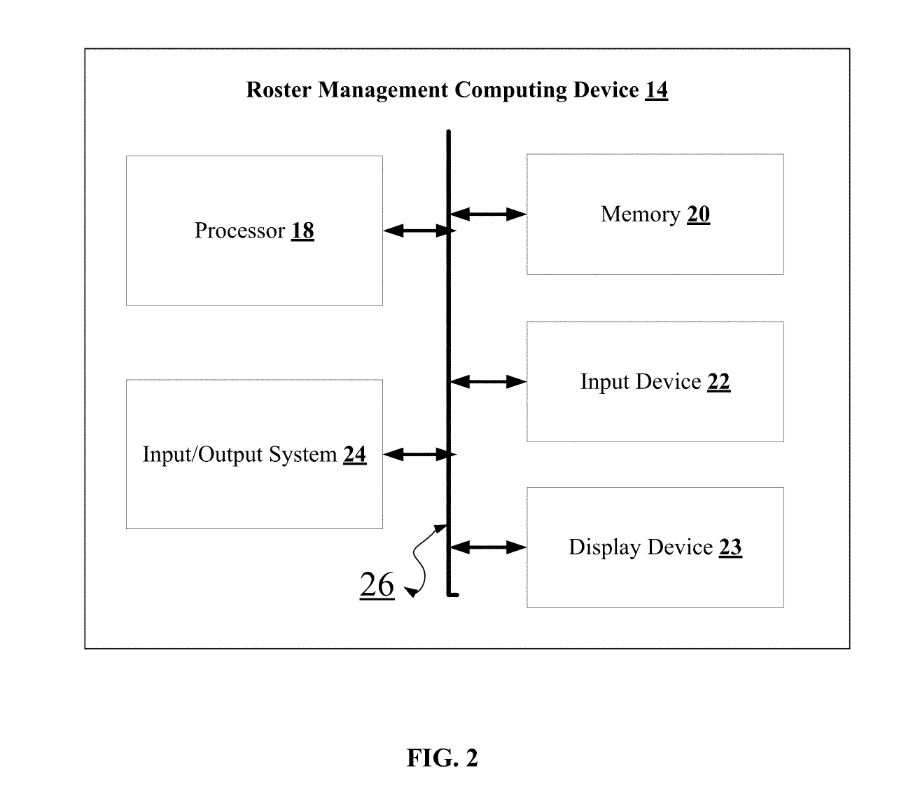

The roster management computing device 14 is within a network environment 10 as illustrated and described with the examples herein, although roster management computing device 14 may perform other types and numbers of functions and in other types of networks. As illustrated in FIG. 2, the roster management computing device 14 includes at least one processor 18, memory 20, input device 22 and display device 23, and input/output (I/O) system 24 which are coupled together by bus 26, although roster management computing device 14 may comprise other types and/or numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

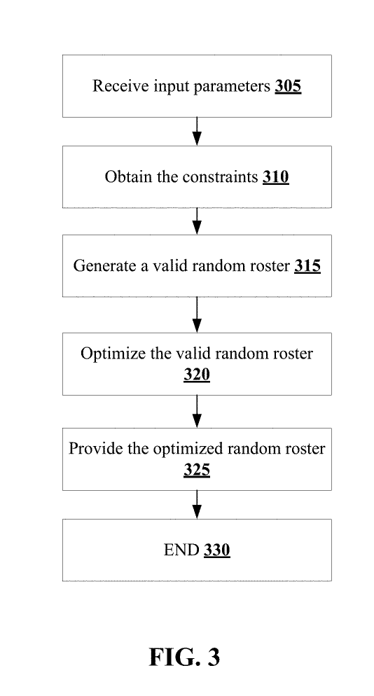

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more programmed instructions of this technology as illustrated and described with reference to the examples herein that may be executed by the one or more processor(s) 18. By way of example only, the flow chart shown in FIG. 3 is representative of programmed steps or actions of this technology that may be embodied or expressed as one or more non-transitory computer or machine readable having stored instructions stored in memory 20 that may be executed by the processor(s) 18, although other types and numbers of programmed instructions and/or other data may be stored.

Input device 22 enables a user, such as an administrator, to interact with the roster management computing device 14, such as to input and/or view data and/or to configure, program and/or operate it by way of example only. By way of example only, input device 22 may include one or more of a touch screen, keyboard and/or a computer mouse.

The display device 23 enables a user, such as an administrator, to interact with the roster management computing device 14, such as to view and/or input information and/or to configure, program and/or operate it by way of example only. By way of example only, the display device 23 may include one or more of a CRT, LED monitor, LCD monitor, or touch screen display technology although other types and numbers of display devices could be used.

The I/O system 24 in the roster management computing device 14 is used to operatively couple and communicate between the roster management computing device 14, the plurality of client computing devices 12(1)-12(n) and plurality of servers 16(1)-16(n) and which are all coupled together by communication network 30. In this example, the bus 26 is a hyper-transport bus, although other bus types and links may be used, such as PCI.

Each of the plurality of client devices 12(1)-12(n) includes a central processing unit (CPU) or processor, a memory, an interface device, and an I/O system, which are coupled together by a bus or other link, although other numbers and types of network devices could be used. The plurality of client devices 12(1)-12(n) communicate with the roster management computing device 14 for receiving list of rosters, although the plurality of client computing devices 12(1)-12(n) can interact with the roster management computing device 14 by other techniques. The plurality of client devices 12(1)-12(n) may run interface application(s), such as a Web browser, that may provide an interface to make requests for and receive content and/or communicate with web applications stored on the plurality of servers 16(1)-16(n) via the communication network 30.

The network environment 10 also includes the plurality of servers 16(1)-16(n). Each of the plurality of servers 16(1)-16(n) includes a central processing unit (CPU) or processor, a memory, an interface device, and an I/O system, which are coupled together by a bus or other link, although other numbers and types of network devices could be used. The plurality of servers 16(1)-16(n) communicate with the roster management computing device 14 through communication network 30, although the servers 16(1)-16(n) can interact with the roster management computing device 14 by other techniques. Various network processing applications, such as CIFS applications, NFS applications, HTTP Web Server applications, and/or FTP applications, may be operating on the plurality of servers 16(1)-16(n) and transmitting content (e.g., files, Web pages) to the plurality of client devices 12(1)-12(n) or the roster management computing device 14 in response to the requests.

Although an exemplary telecommunications network environment 10 with the plurality of client devices 12(1)-12(n), roster management computing device 14 and plurality of servers 16(1)-16(n) are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

An exemplary method for managing on-demand rostering will now be described with reference to FIGS. 1-9. Particularly with reference to FIG. 3, the exemplary method begins at step 305 where the roster management computing device 14 receives one or more rostering input parameters and a choice of the optimization technique(either a hill climbing algorithm or a simulated annealing algorithm) from one of the plurality of client computing devices 12(1)-12(n) or one of the plurality of servers 16(1)-16(n), although the roster management computing device 14 can receive the input parameters from other devices. In this example, the rostering input parameters include start and end dates of the rostering period, availability of employees and their working patterns, list of shift types to be assigned, shift cover requirements for all days of the rostering period, work regulations, and performance metrics, although the rostering input parameters can include other types and/or amounts of information. Further, the working patterns can for example be of the following types: fixed pattern, if-then pattern, and/or forbidden pattern. The fixed pattern relates to assigning all shifts from the pattern to an employee (e.g. night shifts on Mondays). Next, the if-then pattern relates to assigning the entire pattern to an employee when any shift of the schedule matching the first entry of the pattern (e.g. if an employee has a night shift on Thursday, the employees has to work all night shifts until Sunday). Finally, forbidden pattern relates to a series of shifts that must not appear in the schedule (e.g. a day shift immediately after a night shift).

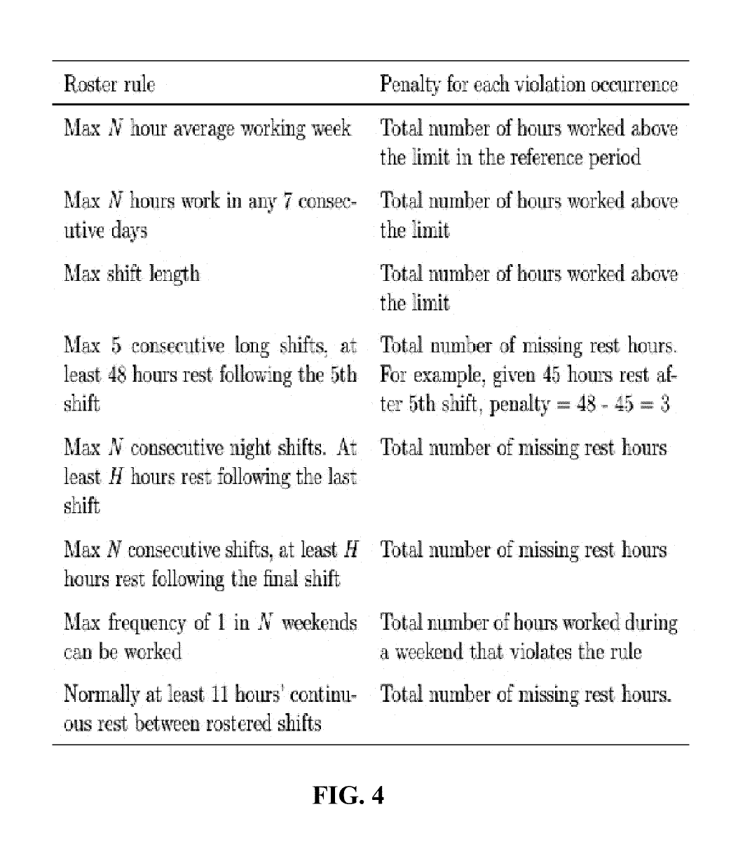

Next in step 310, the roster management computing device 14 obtains one or more rostering constraints from memory 20, although the roster management computing device 14 can obtain the rostering constraints from other sources. In this example, the rostering constraints are divided into two categories: hard constraints and soft constraints, although other types and/or numbers of categories can be used. The hard constraints define feasibility of rosters and must be satisfied in any valid roster and examples of the hard constraints include, cover requirements (minimum number of employees required for each shift) and working patterns. Next, the roster rules are treated as soft constraints that can be violated while making the roster, but each violation is penalized. By way of definition, in this example, roster rules means roster soft constraints, which is a subclass of rostering constraints. Further, the quality of a roster is defined by a total penalty that is calculated as the sum of penalties for all occurrences of rules violation found in a roster and therefore smaller values indicate higher quality rosters. For purpose of illustration and by way of example, the table in FIG. 4 represents examples of the roster rules and the corresponding violation. By way of example, if the roster rule is relating to the maximum number of hour average working week, then the penalty associated for each violation occurrence is the total number of hours worked above the limit in the reference period.

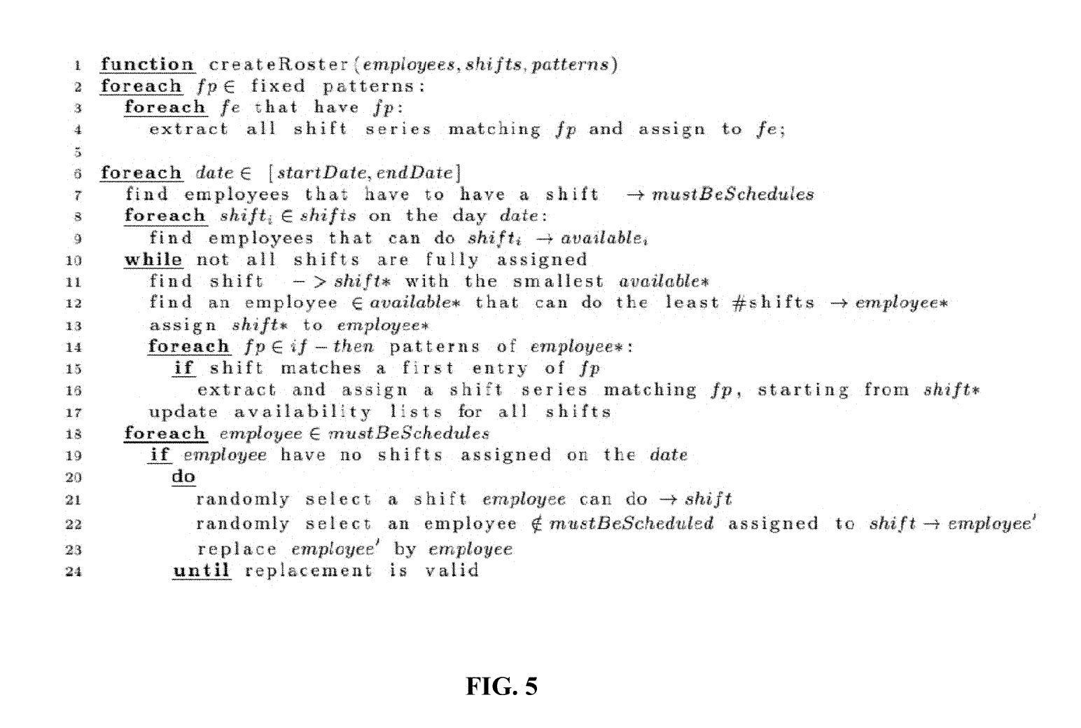

In step 315, the roster management computing device 14 generates a random valid roster based on the received rostering input parameters and the rostering constraints as illustrated by way of the example below, although the random valid roster can be generated using other types or numbers of parameters and/or in other manners. In this example, while generating a valid roster, the roster management computing device 14 is required to satisfy one or more of the following criteria: the cover requirements are satisfied; all fixed patterns are assigned to employees; if any assigned shift matches a first entry of a if-then pattern, then shifts matching the remaining part of the pattern entries have to be assigned; and there are no shift series matching forbidden patterns in employee's schedules. A pseudo-code illustrating generating the random valid roster is illustrated in FIG. 5. By way of example, as illustrated in lines 1-4 of FIG. 5, all fixed patterns are assigned to the corresponding employees. Next, in lines 6-25 of FIG. 5, all other shifts are assigned moving day by day.

Next in step 320, the roster management computing device 14 optimizes the generated valid random roster. In this example, the roster management computing device 14 optimizes the valid random roster by applying a hill climbing technique or a simulated annealing technique. The roster management computing device 14 applys the local operators to the hill climbing technique and the simulated annealing technique to optimize the generated valid random roster, although the roster management computing device 14 can use other techniques to optimize the generated valid random roster.

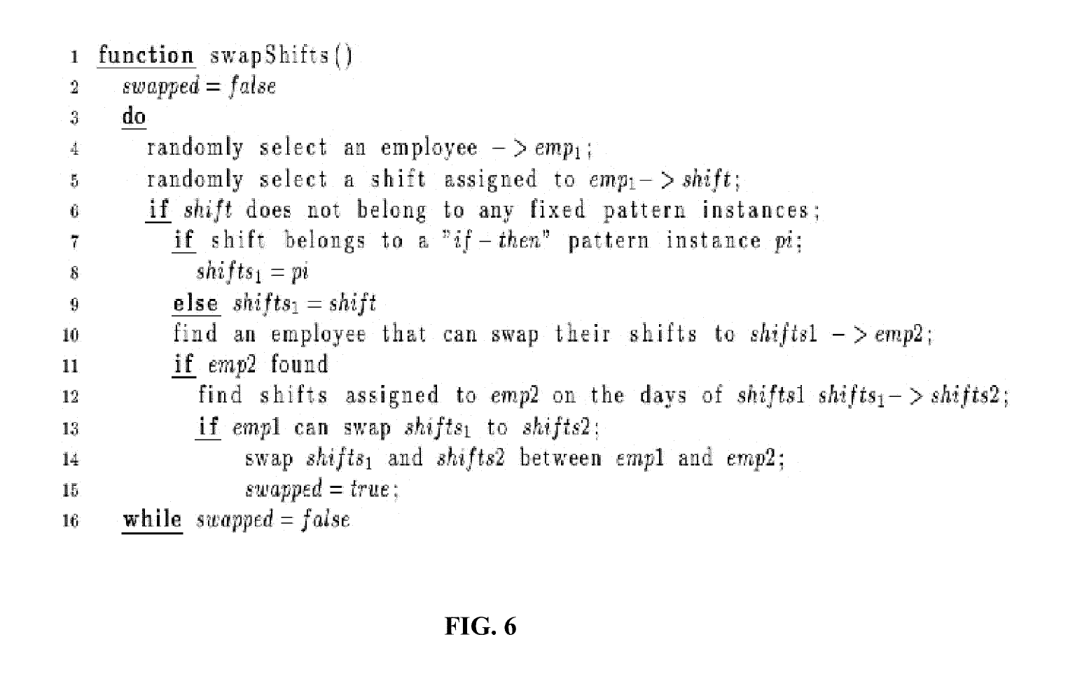

By way of example, local operators relates to swapping shifts between two doctors and/or replacing a doctor on a shift by another doctor, although the local operators can include other types of functions. Additionally in this example, parameter swap probability defines the probability of swapping shifts. Employee replacement is applied with probability 1-swap probability. The pseudo-code to swapping shifts between two doctors is illustrated in FIG. 6. As illustrated in FIG. 6, first, an employee emp1 and a shift assigned to this employee shift are randomly selected. If shift belongs to any instances of fixed patterns, it cannot be swapped, and a new doctor 1-shift1 pair has to be selected. If shift belongs to an if-then pattern instance pi, then with probability 0.5, the whole pattern instance is swapped: shifts1=pi, otherwise the initial shift is swapped: shifts1=shift (if shift does not belong to any “if-then” pattern instances, then shifts1=shift too). Next, an employee whose shifts could be swapped to shifts1 is identified. In this example, the swap must not lead to breaking any fixed or if-then patterns or cause forbidden patterns to occur in employees' schedules. If such employee emp2 is found with shifts shifts2 that can be replaced by shifts 1, then it is determined whether emp1 could do shifts2 instead of shifts1. If it is possible, then shifts1 and shifts2 are swapped between emp1 and emp2. If swapping shifts is not possible for any reasons (shift belongs to a fixed pattern, or an employee whose shifts could be swapped with shifts1 is not found, or empl cannot do shifts2), then the whole process is repeated for a new doctor1shift1 pair.

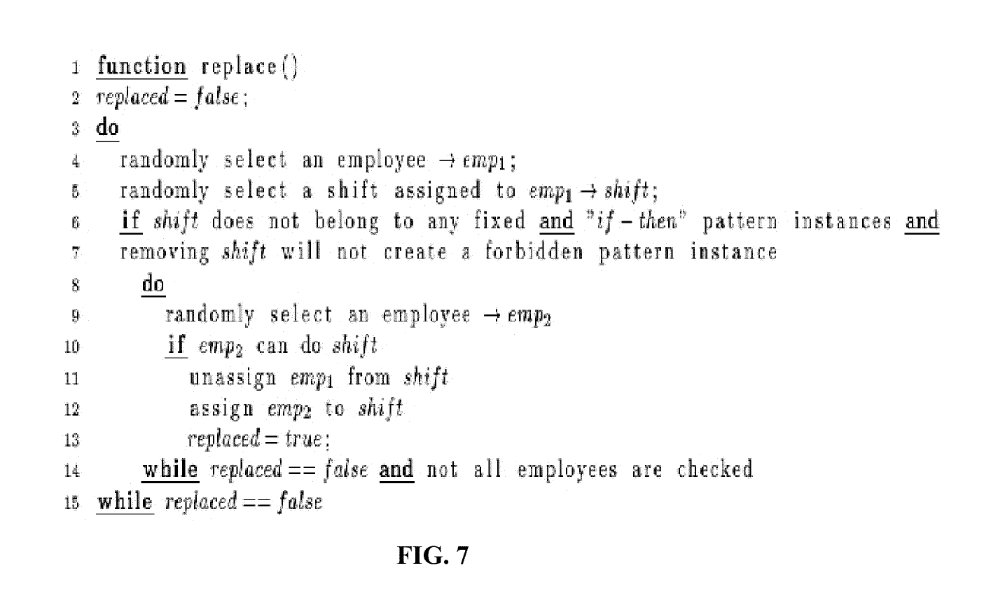

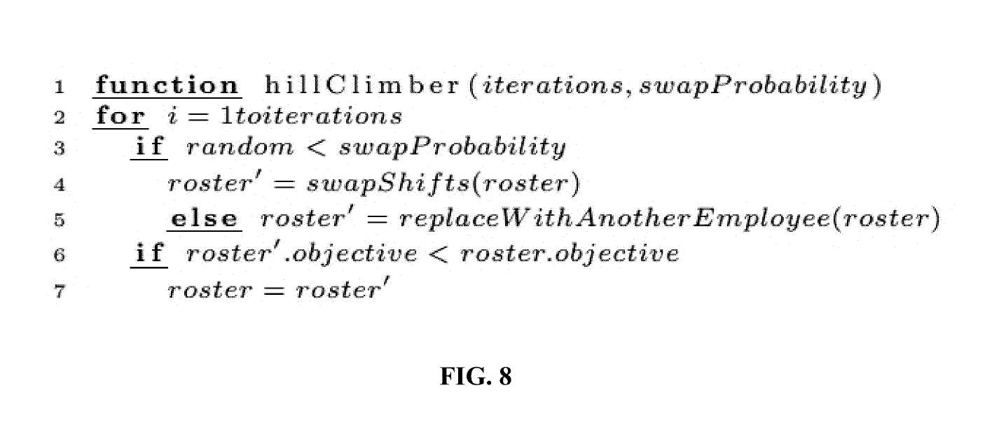

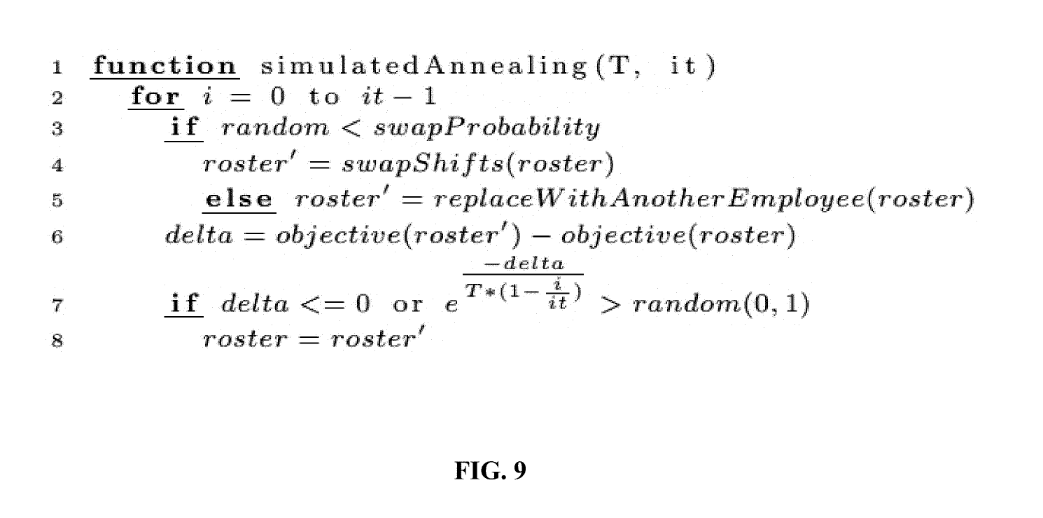

Next, as illustrated in FIG. 7, replacing a doctor begins with selecting an employee and a shift for replacement. If shift does not belong to any fixed or if-then pattern instances and removing it would not create a forbidden pattern match for emp1, then a replacement doctor is identified. For this, a random employee emp2 is selected, and if emp2 can be assigned to shift (i.e. shift assignment would not break any fixed or if-then patterns, nor create a forbidden pattern instance), then the replacement takes place, otherwise a replacement is identified by checking the remaining employees. The process continues until a replacement is found or all employees are checked and none of them can do shift. In this example, a replacement for another randomly selected pair of (emp1) and (shift) is identified and the loop continues until such pair is found and a doctor replacement eventuates. Furthermore, FIG. 8 is an illustration of the pseudo-code for the hill climbing technique that is used by the roster management computing device 14 to optimize the generated valid random roster. The hill climbing technique only accepts changes in the roster that lead to improving the objective function value. FIG. 9 illustrates a pseudo-code of the simulated annealing process.

In this example, the simulated annealing technique accepts roster alterations that improve objective function values, but also, with a certain probability, alterations that lower the objective function value. This approach reduces the risk of getting stuck in local optima, especially in the early iterations of the optimization. The probability of accepting such alterations

$$p = {e}^{\frac{- delta}{T * ( 1 - \frac{i}{it} )}}$$

where delta=objective (roster′)−objective (roster), objective (roster) and objective (roster′) are objective values for the current and altered rosters respectively, T is a parameter of simulated annealing algorithm, i is the number of the current iteration and it is the total number of iterations.

Referring back to FIG. 3, in step 325, the roster management computing device 14 generates a customized interface including the optimized roster and provides the optimized roster to the plurality of client computing devices 12(1)-12(n), although the optimized roster can be provided via other formats. In this example, the roster management computing device 14 generates the customized interface using the one or more roster input parameters that were received and the constraints that were obtained, although the customized interface can be generated using other types or amounts of data. The generated customized interface provided by the roster management computing device 14 includes the optimized roster and the customized interface allows the plurality of client computing devices 12(1)-12(n) to view or modify the optimized roster, although the customized interface can provide other types of functionalities. Additionally in this example, the roster management computing device 14 can control the operations that the plurality of client computing devices 12(1)-12(n) can perform on the customized interface by enforcing certain restrictions on the plurality of client computing devices 12(1)-12(n) and the exemplary method ends in step 330. Using the customized interface, the disclosed technology is able to provide rostering on demand to the client devices.

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing on-demand rostering, the method comprising:
receiving, by a roster management computing device, one or more roster input parameters;
obtaining, by the roster management computing device, one or more roster constraints associated with the received one or more roster input parameters;
determining, by the roster management computing device, an optimized roster based on the received one or more roster input parameters and the obtained one or more roster constraints;
providing, by the roster management computing device, the determined optimized roster on-demand via a customized interface to a client device.

2. The method as set forth in claim 1 further comprising, identifying, by the roster management computing device, a plurality of rostering rules prior to determining the optimized roster.

3. The method as set forth in claim 2 further comprising generating, by the roster management computing device, a random roster based on the identified plurality of rostering rules prior to determining the optimized roster.

4. The method as set forth in claim 1 further comprising, generating, by the roster management computing device, the customized interface based on the obtained one or more roster input parameters and the obtained one or more roster constraints, wherein the generated customized interface comprises the determined optimized roster.

5. The method as set forth in claim 3 further comprising, optimizing, by the roster management computing device, the generated random roster.

6. A roster management computing device comprising:
a processor;
a memory, wherein the memory coupled to the processor which are configured to execute programmed instructions stored in the memory comprising:
receive one or more roster input parameters;
obtain one or more roster constraints associated with the received one or more roster input parameters;
determine an optimized roster based on the received one or more roster input parameters and the obtained one or more roster constraints;
provide the determined optimized roster on-demand via a customized interface to a client device.

7. The device as set forth in claim 6 wherein the processor is further configured to execute programmed instructions stored in the memory to identify a plurality of rostering rules prior to determining the optimized roster.

8. The device as set forth in claim 7 wherein the processor is further configured to execute programmed instructions stored in the memory to generate a random roster based on the identified plurality of rostering rules prior to determining the optimized roster.

9. The device as set forth in claim 6 wherein the processor is further configured to execute programmed instructions stored in the memory to generate the customized interface based on the obtained one or more roster input parameters and the obtained one or more roster constraints, wherein the generated customized interface comprises the determined optimized roster.

10. The device as set forth in claim 8 wherein the processor is further configured to execute programmed instructions stored in the memory to optimize the generated random roster.

11. A non-transitory computer readable medium having stored thereon instructions for managing on-demand rostering comprising machine executable code which when executed by at least one processor, causes the processor to:
receive one or more roster input parameters;
obtain one or more roster constraints associated with the received one or more roster input parameters;
determine an optimized roster based on the received one or more roster input parameters and the obtained one or more roster constraints;
provide the determined optimized roster on-demand via a customized interface to a client device.

12. The medium as set forth in claim 11 further comprising identifying a plurality of rostering rules prior to determining the optimized roster.

13. The medium as set forth in claim 12 further comprising generating a random roster based on the identified plurality of rostering rules prior to determining the optimized roster.

14. The medium as set forth in claim 11 further comprising generating the customized interface based on the obtained one or more roster input parameters and the obtained one or more roster constraints, wherein the generated customized interface comprises the determined optimized roster.

15. The medium as set forth in claim 13 further comprising optimizing the generated random roster.
